(19) United States
(12) Patent Application Publication
(10) Pub. No.: US 2023/0304596 A1
(43) Pub. Date: Sep. 28, 2023

(54) HEATING, VENTILATING AND AIR CONDITIONING ACTUATOR

(71) Applicant: BELIMO HOLDING AG, Hinwill (CH)

(72) Inventors: Silvio GROGG, Wetzikon (CH); Gaëtan MATTHEY, Gibswill (CH); Christoph GRAF, Bubikon (CH)

(73) Assignee: BELIMO HOLDING AG, Hinwil (CH)

(21) Appl. No.: 18/022,689

(22) PCT Filed: Sep. 7, 2021
(86) PCT No.: PCT/EP2021/074580

§ 371 Date: Feb. 22, 2023

(30) Foreign Application Priority Data
Oct. 22, 2020 (CH) 01362/20

(51) Int. Cl. F16K 31/04

(52) U.S. Cl. CPC F16K 31/04; F24F 2013/1433

(57) ABSTRACT

An HVAC actuator (10), comprising: an electric motor (20) configured to move an actuated part (40) coupled to the electric motor (20); an electronic circuit (12) connected to the electric motor (20) and configured to control the electric motor (20); and an energy storage element (22) configured to provide electrical energy to the HVAC actuator (20) in absence of external power supply, wherein the electronic circuit (12) is further configured to receive operating commands directed to the actuated part (40), and to control the electric motor (20) to move the actuated part (40), responsive to the operating commands received in absence of external power supply.

### FIELD OF THE INVENTION

The present invention relates to a Heating, Ventilating and Air Conditioning HVAC actuator. The present invention further relates to an HVAC system comprising one or more HVAC actuator(s) and a controller device.

### BACKGROUND OF THE INVENTION

In the field of Heating, Ventilating and Air Conditioning, HVAC systems typically comprise a fluid transportation system and a plurality of HVAC actuators, including motorized HVAC actuators coupled to actuated parts, such as valves, dampers, pumps, and fans, and other devices connected to the HVAC system, such as flow sensors, pressure sensors, temperature sensors, rotation sensors, position sensors, humidity sensors, etc. In the field of HVAC, the electric motor is coupled, through gears and/or other mechanical coupling, to an actuated part, such as a valve or damper for controlling the flow of a fluid such as water or air. In addition to an electric motor, motorized HVAC actuators are typically provided with a controller having a processor and a data store for storing data content comprising configuration data for operating the HVAC actuator, and for operation-related data recorded by the HVAC actuator. The configuration data includes configuration parameters such as motor speed, closing time, opening time, etc. The operation-related data includes values such as number of cycles, number of movements, maximum travel angle, minimum travel angle, etc. In HVAC applications, the controller is connected to sensors, such as flow sensors, pressure sensors, temperature sensors, humidity sensors, air quality sensors, rotation sensors, position sensors, etc., the configuration data further including configuration parameters such as a target value of flow rate, a set value of altitude for adjusting the measurement of a flow sensor, etc. Moreover, a section of the data store further has stored therein program code for controlling the processor. In HVAC applications, the program code includes various control algorithms for controlling the motor to open and close an orifice of the valve or damper to regulate the flow of fluid, e.g. with regards to differential pressure, room temperature, flow of energy, etc.

HVAC actuators comprising electric motors are commonly used to control actuated parts, such as dampers or valves. The power consumed by the motor of the HVAC actuators is typically provided by an external energy source, such as mains supply which requires an adequate wiring of the HVAC actuators.

Upon installation and/or servicing, HVAC actuators often need to be manually commissioned, calibrated and/or configured before their normal/regular operation. In certain use cases, this commissioning, calibration and/or configuration upon installation and/or servicing is performed without the HVAC actuator being connected to an external energy source, either because the wiring infrastructure for the external energy source is not yet available and/or the connection to the external energy source is not desired (e.g. for safety reasons) and/or the HVAC actuators may only be connected to an external energy source after being commissioned, calibrated and/or configured.

Conventionally, HVAC actuators are manually commissioned, calibrated and/or configured using mechanical operating means, such as a manual crank, lever etc. However, providing mechanical operating means merely for such installation and/or servicing procedures unnecessarily increases the mechanical complexity of the HVAC actuators, thereby increasing their production and/or maintenance costs. Furthermore, mechanical operating means are susceptible to wear and may be prone to mechanical failure. Also, mechanical operating means often require additional openings in the housing of the HVAC actuator which require additional sealing elements to avoid exposure to contaminants/dirt.

### SUMMARY OF THE INVENTION

It is an object of embodiments disclosed herein to provide an HVAC actuator, which at least partially improve the prior art and avoid at least part of the mentioned disadvantages of the prior art. In particular, it is an object of embodiments disclosed herein to provide an HVAC actuator which enables a cost and mechanically efficient manual commissioning, calibration and/or configuration upon installation/servicing without the need for an external energy source.

According to embodiments of the present disclosure, this object is addressed by an HVAC actuator, comprising: an electric motor, an electronic circuit and an energy storage element. The electric motor is configured to move an actuated part coupled (in particular mechanically coupled) to the electric motor. The electronic circuit is connected to the electric motor and configured to control the electric motor. The energy storage element is configured to provide electrical energy to the HVAC actuator in absence of external power supply. External power supply hereby refers to any form of energy source that is not structurally part of the HVAC actuator, such as mains power supply. The electronic circuit is further configured to receive operating commands directed to the actuated part and to control the electric motor such as to move the actuated part, responsive to the operating commands received in absence of external power supply. Thereby, the user is able to manually commission, calibrate and/or configure the HVAC actuator using an operating element without the need of an external energy source. Manual operation is particularly advantageous during installation and/or servicing without the HVAC actuator being connected to an external energy source, either because the wiring infrastructure for the external energy source is not yet available and/or the connection to the external energy source is not desired (e.g. for safety reasons) and/or the HVAC actuators may only be connected to an external energy source after being commissioned, calibrated and/or configured.

Embodiments according to the present disclosure are advantageous as they allow reducing the number of installation “visits” required to deploy HVAC actuators in an HVAC system since there is no need for a technician installing the HVAC actuator to return when the wiring infrastructure for the external energy source is available just to commission, calibrate and/or configure the HVAC actuator(s).

According to embodiments of the present disclosure, the HVAC actuator further comprises an operating element for generating the operating commands directed to the actuated part based on operating input from a user. The operating element is/comprises one or more switching element(s), such as push button(s) and/or control knob(s).

Alternatively, or additionally, according to embodiments of the present disclosure, the operating element comprises a communication interface configured to receive operating commands from a controller device external to the HVAC actuator.

The controller device may be a mobile computing device having a user interface, in particular a graphical user interface, for receiving operating input from a user, the mobile computing device being configured to generate the operating commands directed to the actuated part based on the operating input.

According to embodiments of the present disclosure, the communication interface comprises a radio communication interface configured to establish a radio communication link with a corresponding radio communication interface of the controller device and to receive the operating commands via the radio communication link.

According to embodiments of the present disclosure, the communication interface comprises a wire-based communication interface configured to establish a wire-based communication link with a corresponding wire-based communication interface of the controller device and to receive the operating commands via the wire-based communication link.

According to embodiments of the present disclosure, the energy storage element is a battery, in particular a rechargeable battery such as a Lithium-ion battery.

In order to avoid damage to the energy storage element, according to embodiments of the present disclosure, the HVAC actuator further comprises a heating element, the electronic circuit being configured to control the heating element such as to heat the energy storage element.

To conserve electric energy, according to embodiments of the present disclosure, the electronic circuit is further configured to: switch the HVAC actuator into a low power mode (such as a standby mode); receive a wake-up command; and wake the HVAC actuator from the low power mode upon receipt of the wake-up command. The HVAC actuator may further comprise a wake-up trigger element, such as a trigger switch or a radio communication receiver, the trigger element being configured to generate the wake-up command in response to user input. Alternatively, of additionally, the wakeup command is generated by the operating element in response to user input.

According to embodiments of the present disclosure, the electronic circuit is further configured to control a charging level of the energy storage element such as to prevent a charging level below a deep-discharge level and/or a charging level above an overcharge level in order to extend the lifetime and/or charge holding interval of the energy storage element. Furthermore, if the charging level of the energy storage element approaches a threshold charge level, the electronic circuit shall switch the HVAC actuator into a low power mode (such as a standby mode) and disregard said wake-up command until the energy storage element is charged again to prevent damage of the energy storage element.

According to embodiments of the present disclosure, the actuated part comprises a valve and/or a flap for regulating a flow of fluid.

The above-identified objectives are further addressed by an HVAC system comprising: one or more HVAC actuator(s) (according to embodiments disclosed herein) connected to one or more actuated parts and a controller device, in particular a mobile computing device. The controller device comprises: a communication interface configured to establish a communication link with the communication interface(s) of the HVAC actuator(s) and a user interface, in particular a graphical user interface, for receiving operating commands from a user. The controller device is configured to transmit the operating commands to the HVAC actuator(s) via the communication link.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

The herein described disclosure will be more fully understood from the detailed description given herein below and the accompanying drawings which should not be considered limiting to the disclosure described in the appended claims. The drawings which show:

FIG. 1: a highly schematic perspective view of an embodiment of an HVAC actuator according to embodiments of the present disclosure, comprising switching elements;

FIG. 2: a block diagram illustrating an embodiment of an HVAC actuator according to embodiments of the present disclosure;

FIG. 3: a highly schematic perspective view of a further embodiment of an HVAC actuator according to embodiments of the present disclosure, comprising a radio communication interface;

FIG. 4: a block diagram of an embodiment of an HVAC system according to embodiments of the present disclosure, comprising an HVAC actuator and a mobile computing device;

FIG. 5: a highly schematic perspective view of a further embodiment of an HVAC actuator according to embodiments of the present disclosure, comprising a wire-based communication interface; and

FIG. 6: a block diagram of a further embodiment of an HVAC actuator according to embodiments of the present disclosure.

### DETAILED DESCRIPTION

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

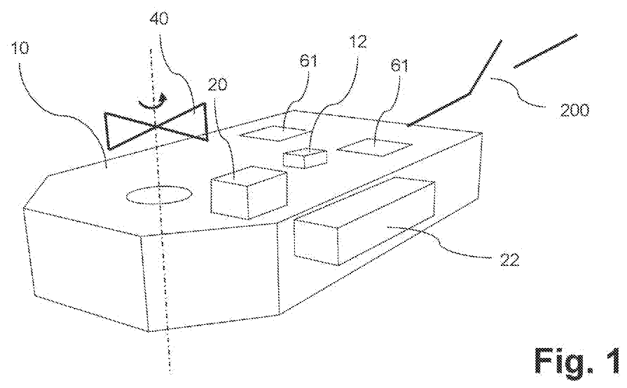

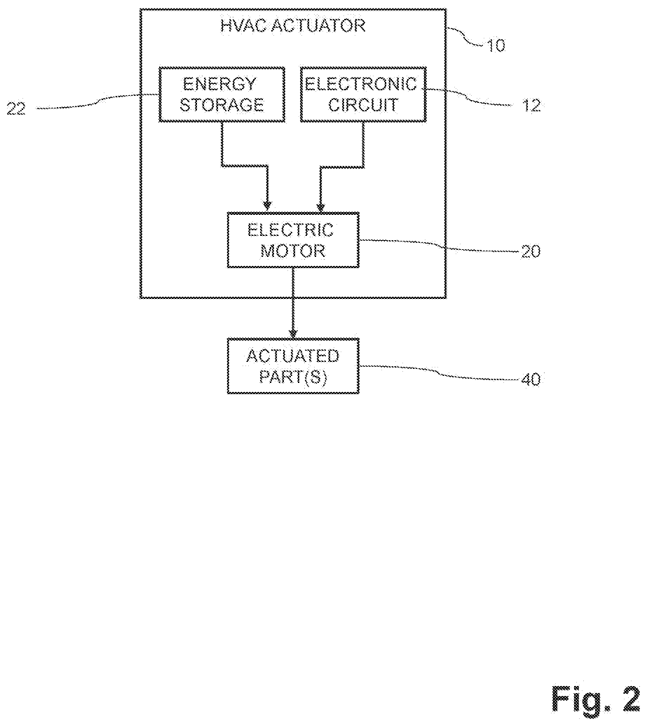

FIGS. 1 and 2 show a highly schematic perspective view respectively a block diagram of an embodiment of an HVAC actuator 10 according to embodiments of the present disclosure. As illustrated, the HVAC actuator 10 comprises an electric motor zo, an electronic circuit 12 and an energy storage element 22. The electric motor zo is configured to move an actuated part 40 coupled to the electric motor zo. The actuated part 40 is not part of the HVAC actuator 10. The electronic circuit 12 is connected to the electric motor zo and configured to control the electric motor zo. The energy storage element 22 is configured to provide electrical energy to the HVAC actuator zo in absence of external power supply, illustrated by a broken connection with reference numeral zoo. Operating element(s) 60 is provided to allow a user to manually commission, calibrate and/or configure the HVAC actuator 10. The embodiment of the HVAC actuator 10 shown on FIG. 1 comprises switching elements 61 as operating elements such as electro-mechanical switches.

To conserve electric energy, according to embodiments of the present disclosure, the electronic circuit 12 is further configured to: switch the HVAC actuator 10 into a low power mode (such as a standby mode); receive a wake-up command; and wake the HVAC actuator 10 from the low power mode upon receipt of the wake-up command. According to a particular embodiment of the present disclosure, the electronic circuit 12 is configured to wake the HVAC actuator 10 from the low power mode upon actuation of any of the switching elements 61 and to switch the HVAC actuator 10 into a low power mode when the switching elements 61 have not been actuated for a certain period of time.

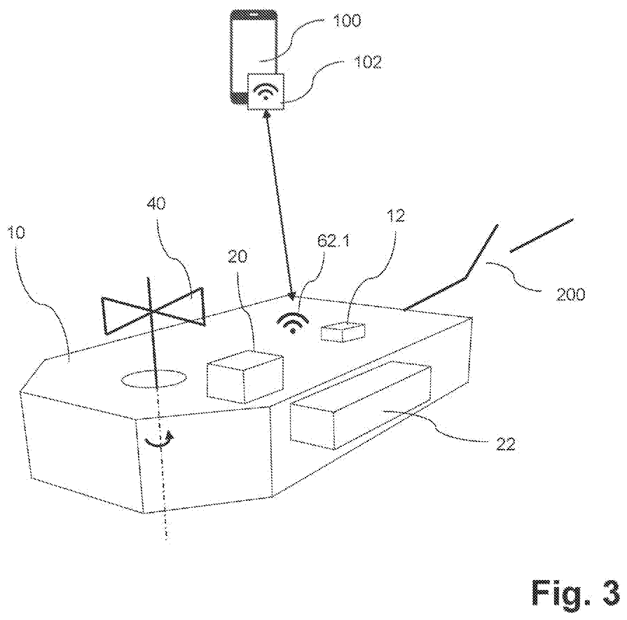

FIGS. 3 to 5 show highly schematic perspective views respectively a block diagram of further embodiments of an HVAC actuator 10 comprising a communication interface 62 configured to receive operating commands from a controller device 100 external to the HVAC actuator 10.

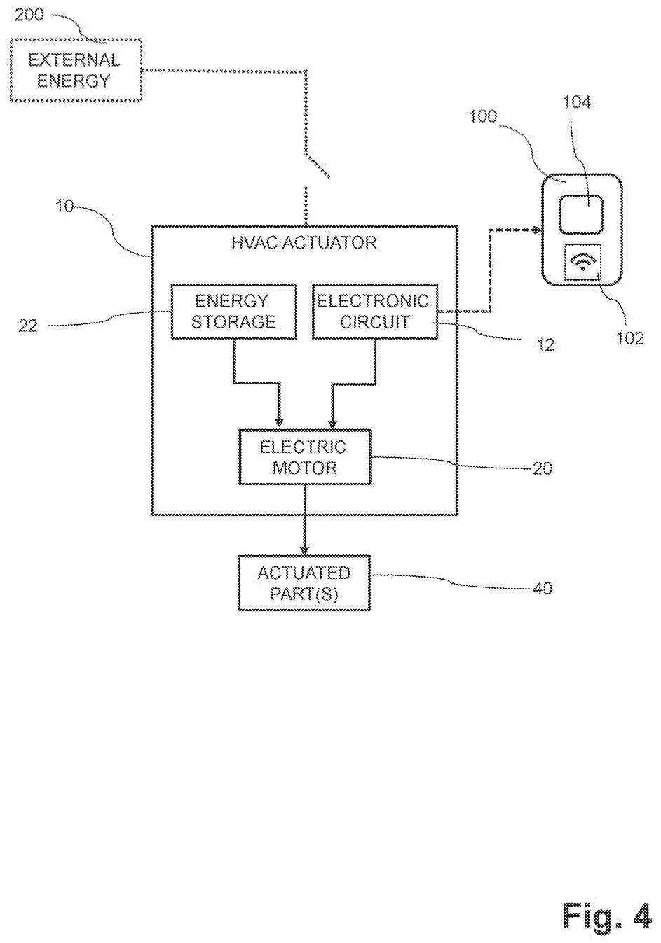

As illustrated on FIGS. 3 and 4, according to embodiments of the present disclosure, the communication interface 62 comprises a radio communication interface 62.1 configured to establish a radio communication link with a corresponding radio communication interface of the controller device 100, such as a mobile computing device 100 having a user interface 104.

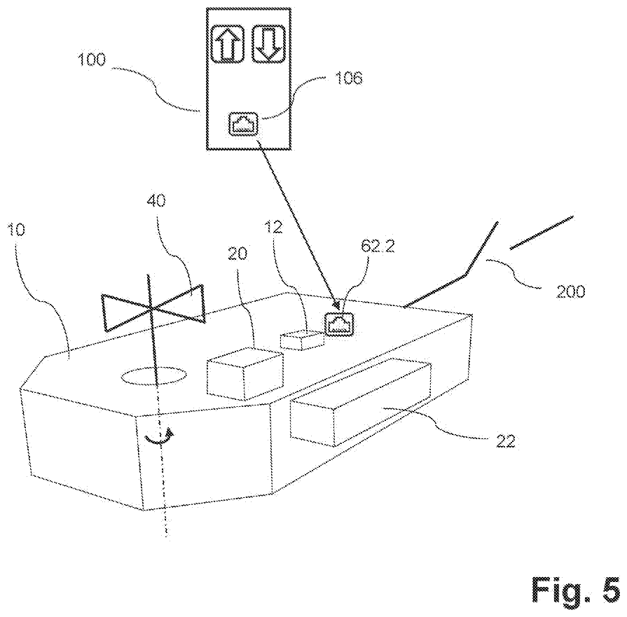

FIG. 5 shows a highly schematic perspective view of a further embodiment of an HVAC actuator 10 according to embodiments of the present disclosure, comprising a wire-based communication interface 62.2 configured to establish a wire-based communication link with a corresponding wire-based communication interface 106 of the controller device 100 and to receive the operating commands via the wire-based communication link.

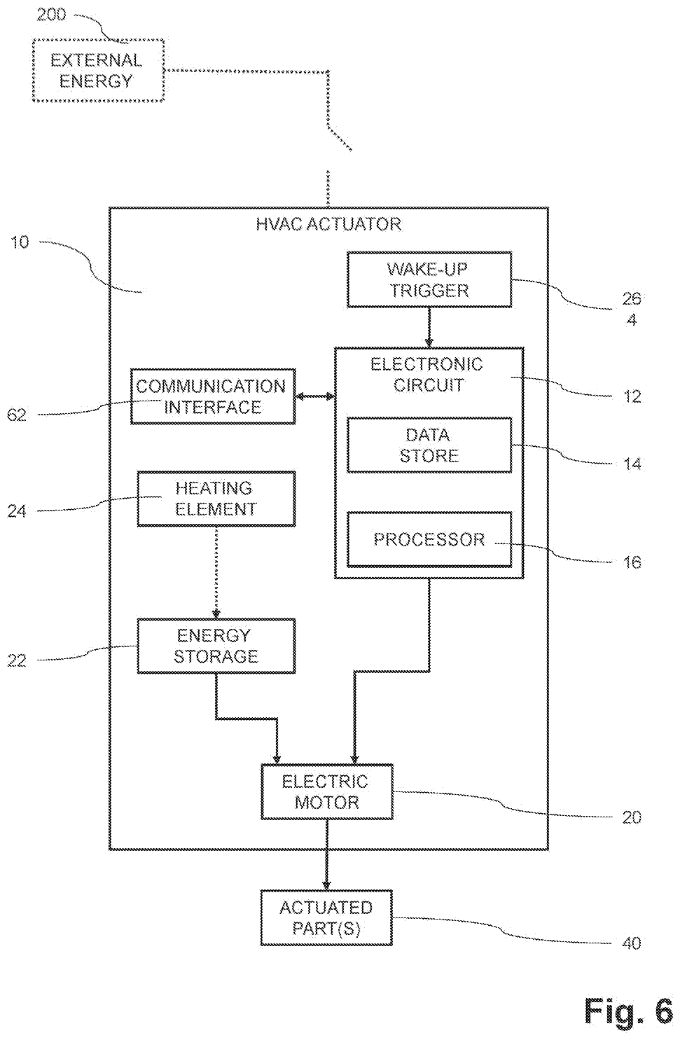

FIG. 6 shows a block diagram of a further embodiment of an HVAC actuator 10 according to embodiments of the present disclosure. The electronic circuit 12 of the HVAC actuator 10 comprises: a data store 14 for storing data content comprising configuration data for operating the HVAC actuator 10 and/or for operation-related data recorded by the HVAC actuator 10 and a processor 16 for executing computer readable instructions. In order to avoid damage to the energy storage element 22, the HVAC actuator further comprises a heating element 24, the electronic circuit 12 being configured to control the heating element 24 such as to heat the energy storage element 22.

Furthermore, the HVAC actuator 10 comprises a wake-up trigger 26 configured to generate the wake-up command (such as a wake-up pulse). According to embodiments of the present disclosure, the wake-up trigger 26 is an electrical switch or a radio communication receiver (such as an NFC receiver).

### LIST OF REFERENCE NUMERALS

HVAC actuator 10
electronic circuit 12
data store 14
processor 16
communication interface 18
electric motor 20
energy storage element 22
heating element 24
wake-up trigger 26
actuated part 40
sensor 24
operating element 60
switching element(s) 61
communication interface 62
radio communication interface 62.1
wire-based communication interface 62.2
controller device (such as mobile computing device) 100
radio communication interface (of controller device) 102
user interface (of controller device) 104
wire-based communication interface (of controller device) 106

1. An HVAC actuator, comprising:
an electric motor configured to move an actuated part coupled to the electric motor;
an electronic circuit connected to the electric motor and configured to control the electric motor; and
an energy storage element configured to provide electrical energy to the HVAC actuator in absence of external power supply,
wherein the electronic circuit is further configured to receive operating commands directed to the actuated part, and to control the electric motor to move the actuated part, responsive to the operating commands received in absence of external power supply.

2. The HVAC actuator according to claim 1, wherein the electronic circuit is configured to enable a user to manually commission, calibrate and/or configure the HVAC actuator without the need of an external energy source.

3. The HVAC actuator according to claim 1, further comprising an operating element for generating the operating commands directed to the actuated part based on operating input from a user.

4. The HVAC actuator according to claim 3, wherein the operating element comprises one or more switching elements.

5. The HVAC actuator according to claim 3, wherein the operating element comprises a communication interface configured to receive operating commands from a controller device external to the HVAC actuator.

6. The HVAC actuator according to claim 5, wherein the controller device comprises a mobile computing device having a user interface for receiving operating input from a user, the mobile computing device being configured to generate the operating commands directed to the actuated part based on the operating input.

7. The HVAC actuator according to claim 5, wherein the communication interface comprises a radio communication interface configured to establish a radio communication link with a corresponding radio communication interface of the controller device and to receive the operating commands via the radio communication link.

8. The HVAC actuator according to claim 5, wherein the communication interface comprises a wire-based communication interface configured to establish a wire-based communication link with a corresponding wire-based communication interface of the controller device and to receive the operating commands via the wire-based communication link.

9. The HVAC actuator according to claim 1, wherein the energy storage element is a battery.

10. The HVAC actuator according to claim 1, further comprising a heating element, the electronic circuit being configured to control the heating element to heat the energy storage element.

11. The HVAC actuator according to claim 1, wherein the electronic circuit is further configured to:
switch the HVAC actuator into a low power mode;
receive a wake-up command; and
wake the HVAC actuator from the low power mode upon receipt of the wake-up command.

12. The HVAC actuator according to claim 11, further comprising a wake-up trigger configured to generate the wake-up command in response to user input.

13. The HVAC actuator according to claim 12, wherein the operating element is configured to generate the wake-up command in response to user input.

14. The HVAC actuator according to claim 1, wherein the electronic circuit is further configured to control a charging level of the energy storage element to prevent a charging level below a deep-discharge level and/or to prevent a charging level above an overcharge level.

15. The HVAC actuator according to claim 1, wherein the actuated part comprises a valve and/or a flap for regulating a flow of fluid.

16. An HVAC system comprising:
one or more HVAC actuators according to claim 5 connected to one or more actuated parts; and
a controller device comprising:
a communication interface configured to establish a communication link with the one or more communication interfaces of the one or more HVAC actuators; and
a user interface for receiving operating commands from a user,
wherein the controller device is configured to transmit the operating commands to the one or more HVAC actuators via the communication link.

17. The HVAC actuator according to claim 4, wherein the one or more switching elements comprise one or more push buttons and/or one or more control knobs.

18. The HVAC actuator according to claim 9, wherein the battery comprises a rechargeable battery or a Lithium-ion battery.

19. The HVAC actuator according to claim 12, wherein, the wake-up trigger comprises a trigger switch or a radio communication receiver.

20. The HVAC system according to claim 16, wherein the controller device is a mobile computing device.
